(19) United States
(12) Patent Application Publication
(10) Pub. No.: US 2001/0013891 A1
(43) Pub. Date: Aug. 16, 2001

(54) VIDEO CONFERENCING TERMINAL

(76) Inventor: CHRIS HAMILTON, MONTCLAIR, NJ (US)

Correspondence Address: KAPLAN & GILMAN LLP, 900ROUTE 9 NORTH, WOODBRIDGE, NJ, 07095

(21) Appl. No.: 09/335,129

(22) Filed: Jun. 17, 1999

(51) Int. Cl. H04N 7/14; H04M 11/00

(52) U.S. Cl. 348/14.08; 348/14.01; 379/93.17; 379/93.21

(57) ABSTRACT

An integrated video conference terminal is disclosed which comprises a monitor for displaying video images from other conferees, lights and a video camera for transmitting the conferees image to a server, speakers for emitting audio, and an optional coin/credit card input for allowing for public operation similar to a pay phone.

### TECHNICAL FIELD

This invention relates to video conferencing and more specifically, to a video conferencing terminal particularly adapted to be utilized in a “pay phone” type environment, but usable without such environment as well.

### BACKGROUND OF THE INVENTION

Video conferencing systems are becoming more widely used due in part to the availability of the Internet. In a video conferencing system, a personal computer in utilized to display the image of one or more other conferees, and a bridging circuit is utilized to connect all of the conferees' systems together. Typically, a personal computer is utilized as the monitor with the audio signal being transmitted through the PC or through a separate telephone.

This is a fairly cumbersome arrangement as it requires numerous separate components (speakers, telephone, computer monitor, etc.) and is also not amenable to utilizing in a “pay phone” type environment. Specifically, there is no provision to allow for users to join a video conference from a public pay phone.

### SUMMARY OF THE INVENTION

The above and other problems of the prior art are overcome in accordance with the present invention which relates to an integrated video conferencing monitor/terminal which comprises the required components for a video conference contained within a single module and possibly activatable by means of a credit card or coins.

### BRIEF DESCRIPTION OF THE DRAWINGS

FIG. 1 shows an exemplary video conference terminal in accordance with the present invention.

### DETAILED DESCRIPTION OF THE PREFERRED EMBODIMENT

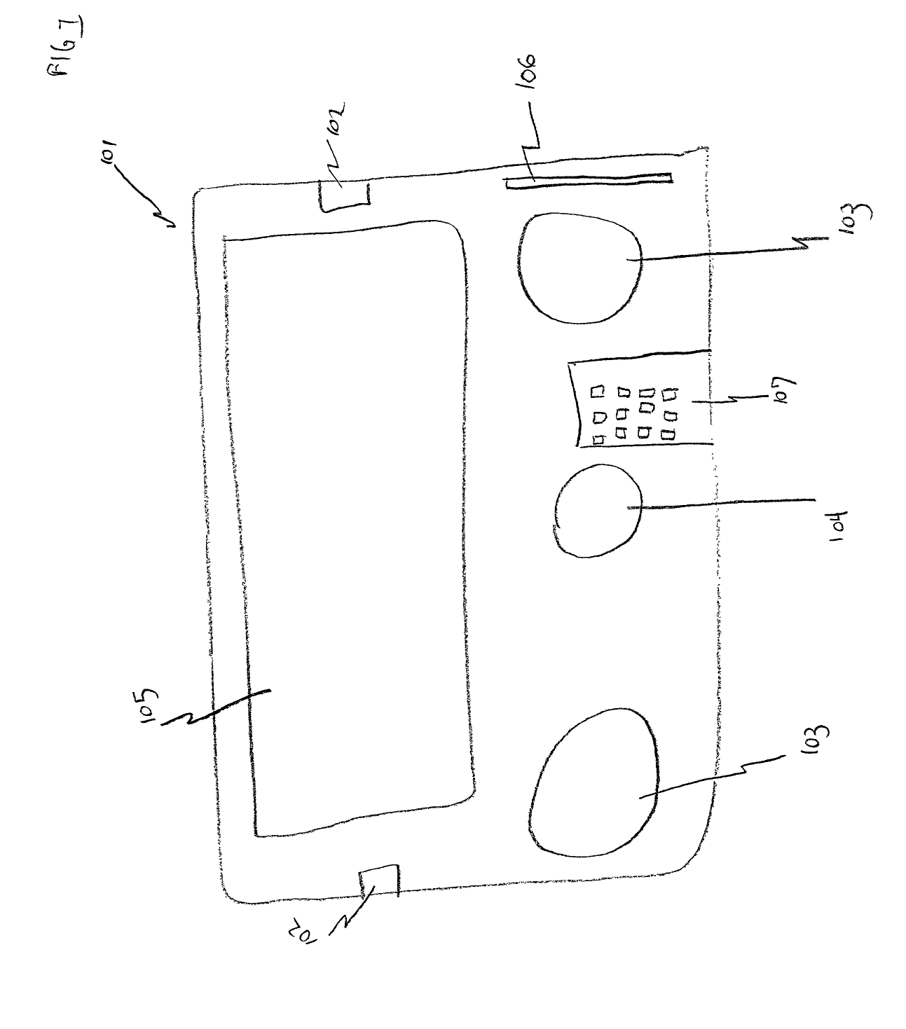

FIG. 1 shows a video conference terminal in accordance with the present invention. The arrangement at FIG. 1 includes speakers 102, a display area 105, lights 103, a video monitor 104, keypad 107, and payment means 106, which may be a credit card reader and/or dollar bill or coin slot. The entire arrangement is preferably contained within a hard plastic or metal casing, and can be installed in an office or public environment.

The camera 104 is a conventional digital camera arranged to digitize the received image and transmit it to a remote conference server bridge. The original conference is set up by input from keypad 107 in accordance with standard telephony techniques. This keypad may convey DTMF or pulse tones, as a telephone keypad does, or it may convey digital data such as a computer keypad, or both.

In operation, a user swipes the credit card or inserts the appropriate amount of funds into payment means 106 and the system is activated. The user then joins the particular conference by utilizing the keypad 107 to dial up the server. The images of a variety of other conferees are displayed on display 105, and speakers 102 emit the combined audio signals from all other conferees, as is typical in conferencing systems.

In low cost video terminals, it is often required to provide additional lighting in order to achieve the required dynamic range of the video signal. Accordingly, lights 103 are installed on opposite sides of video camera 104 to point toward the subject and illuminate the subject.

As the video signal is received, it is digitized by camera 104 and transmitted to the server while simultaneously, a video signal from the server is displayed on monitor 105.

The foregoing video conference station may be connected to an Internet server via a standard telephone connection, or may utilize a high speed data link, telephone line, etc. The video and audio signals, as well as payment information in the case of payment means 106 being a credit card device, may be transmitted over the same communication lines as the video and audio information.

The above describes the preferred embodiment of the invention. Various other modifications or additions will be apparent to those of ordinary skill in the art, and are intended to be covered by the following claims.

1. A video conference station comprising:
a monitor;
means connected to said monitor for displaying one of more video images from one or more remotely located conferees;
a housing within which said monitor is contained;
at least one lighting means contained within said housing, said lighting means being activatable by a user when a video conference is occurring and being arranged to illuminate a user of said video conference station;
keypad means for facilitating entry of information by a user for arranging, exiting, and changing parameters of a video conference;
audio means for conveying an audio signal from one or more conferees;
camera means mounted within said housing and directed toward a user of said video conference station; and,
payment means for activating said monitor, said audio means, said lighting means said camera and said keypad means upon the entry of payment.

2. The system of claim 1 wherein said payment means is a credit card reading device.

3. The system of claim 1 wherein said monitor comprises means for displaying plural images, one from each of the plurality of other conferees.

4. The system of claim 2 wherein said lighting means are disposed below said monitor.

5. The system of claim 4 wherein said monitor is connected to a data network server by means of a telephone line.

6. The system of claim 4 wherein said monitor is connected to said data network server by a data connection.

7. A video conference station for use in a video conferencing system comprising
an outer casing;
display means, lighting means, and a video camera, all being mounted within said outer casing, said video camera and said lighting means being directed toward the same area, said display means being viewable from said same area; and,
activating means for activating said display means, said lighting names, a said video camera upon request by a user.

8. The video conference station of claim 7 further comprising keypad means for entering data.

9. The video conference station of claim 8 wherein said keypad means comprises means for generating DTMF tones.

10. The video conference station of claim 9 further comprising payment means for accepting a credit card and wherein said activating means only operates in response to payment received by said payment means.
